(19) United States
(12) Patent Application Publication
(10) Pub. No.: US 2007/0086708 A1
(43) Pub. Date: Apr. 19, 2007

(54) Light transmission/reception module and light transmission/reception device

(75) Inventors: Kazuhiro Nojima, Yokohama-shi (JP); Satoshi Furusawa, Osaka-shi (JP); Toru Nishikawa, Hirakata-shi (JP); Hiroaki Asano, Yokohama-shi (JP)

Correspondence Address: PEARNE & GORDON LLP, 1801 EAST 9TH SRTEET, SUITE 1200, CLEVELAND, OH, 44114-3108, US

(73) Assignee: Matsushita Electric Industrial Co., Ltd., Kadoma-shi, Osaka (JP)

(21) Appl. No.: 10/576,660

(22) PCT Filed: Dec. 6, 2004
(86) PCT No.: PCT/JP04/18131

§ 371 Date: Apr. 21, 2006

(30) Foreign Application Priority Data
Jan. 15, 2004 (JP) 2004-008118

(51) Int. Cl. G02B 6/36

(52) U.S. Cl. 385/88; 385/89; 385/92

(57) ABSTRACT

Providing an optical transceiver module that reduces electric crosstalk between a light emitting device and a photodetector while providing an excellent high-frequency characteristic, and an optical transceiver including the same. According to the invention, a first metal plate having a first substrate for mounting a light emitting device and a at second metal plate having a second substrate for mounting a photodetector are provided separately and independently of each other in a resin package, thus reducing the parasitic capacitance. This provides an optical transceiver module capable of suppressing electric crosstalk where part of a high-frequency signal causes a variation in the potential at a terminal of a photodetector while improving the high frequency characteristic in driving the light emitting device with a high-frequency signal, and an optical transceiver including the same.

### FIELD OF THE INVENTION

The present invention relates to an optical transceiver module where a light emitting device and a photodetector are arranged in a same module in order to perform bidirectional communications and an optical transceiver including the same, and in particular to an optical transceiver module that reduces electrical interference between a light emitting device and a photodetector while providing an excellent high-frequency characteristic, and an optical transceiver including the same.

### BACKGROUND INFORMATION

Recently, as the Internet communications are getting faster, an optical communications system called FTTH (Fiber To The Home) are in widespread use in trunk line communications systems as well as in subscriber line communications. In such an optical communications system, a method is employed where a single fiber cable is used to transmit optical signals having different wavelengths for upstream and downstream transmissions, for example using a near-infrared light having a wavelength of upstream 1.3 μm and downstream 1.5 μm.

A variety of attempts have been made to provide these systems at low cost. There is proposed a transceiver module that attains a low-cost product by incorporating a light emitting device at the transmitter and a photodetector at the receiver in a single package.

In case a light emitting device and a photodetector are incorporated in a package, electric crosstalk occurs where a drive current signal of the light emitting device interferes with the photodetector or an electric signal of a receiver circuits. The amount of crosstalk is not negligible or substantial. In particular, in case a signal is transmitted at a speed over gigabits/second, the resulting degradation of communications characteristic is eminent.

An optical transmitter module that aims at reducing the crosstalk is proposed for example in JP-A-2001-345475. The interior of the optical transmitter module disclosed therein will be described referring to FIG. 10 that provides a plan view of the module.

An optical transmitter module 100 in FIG. 10 includes a metal plate 101 inside a package 100A and a first (outer) lead 102A through an eighth (outer) lead 102H that electrically conducts the interior and the exterior of the package 100A. The metal plate 101 has a first substrate 103 and a second substrate 106 that are separated and independent of each other. On the first substrate 103 is mounted a light emitting device 104. On the second substrate 106 is mounted a light emitting device 107.

The configuration and operation of the light emitting device 104 and the light emitting device 107 in the optical transmitter module 100 are described below.

The light emitting device 104 is arranged to emit light by feeding a current from the upper surface (anode terminal) to the lower surface (cathode terminal). To be more precise, the current flows from the first lead 102 to the lower surface of the light emitting device 104 via a first bonding wire 105A and an electrode 104A for the anode terminal of the light emitting device 104 on the first substrate 103. The light emitting device 104 is driven with a current from outside the package 100A via a second bonding wire 105B a second lead 102B connected to a predetermined terminal (not shown) of the upper surface of the light emitting device 104.

The photodetector 107 applies a voltage across the cathode terminal and the anode terminal on the lower surface of the terminal. This causes a current to flow from the cathode terminal to the anode terminal when an optical signal is received and the amount of current to change in accordance with the level of the light received. That is, the input terminal of an amplifier (not shown) external to the package 100 is connected to the cathode terminal of the photodetector 107 via a third lead 102C, a third bonding wire 105C, and a cathode terminal electrode 107A of a photodetector 107 on the second substrate 106. The anode terminal of the photodetector 107 is connected to a dc voltage source (not shown) external to the package 100A via an anode terminal electrode 107B, a fourth bonding wire 105D and a fourth lead 102D. Thus, by applying a voltage across the third lead 102C and the fourth lead 102D from outside the package 100A, it is possible to obtain a photodetector current in accordance with the optical signal level of an optical signal received from the distant party.

Next, the configuration and operation of the optical system of the optical transceiver module 100 will be described.

Referring to FIG. 10, inside the second substrate 106 (not shown) are arranged one end of a first optical fiber 108A and one end of a second optical fiber 108B across a wavelength filter (not shown) such as an interference film filter. The other end (left end in FIG. 10) of the first optical fiber 108A is arranged at the light-emitting part of the light emitting device 104 (not shown). The other end of the second optical fiber 108B serves as an external optical interface (optical connector) of the package 100A.

Thus, an optical signal output from the light emitting device 104 propagates inside the optical fiber 108A rightward in FIG. 10, passes through a wavelength filter, propagates inside the optical fiber 108B rightward, and is output from the optical transceiver module 100. An optical signal input from outside the distant party via the optical fiber 108B is reflected by a wavelength filter and received as an optical signal by the light-receptive part of the photodetector 107.

As mentioned above, the optical transceiver module 100 described in JP-A-2001-345475 uses two separate substrates for mounting a light emitting device 104 and a photodetector 107 respectively, that is, a first substrate 103 for mounting the light emitting device 104 and a second substrate 106 for mounting the photodetector 107 in order to reduce electric crosstalk.

Use of a low-cost resin package for one used by the optical transceiver module is under study in order to further reduce the overall cost.

In the optical transceiver module 100 using the package 100A made of resin, parasitic inductances L₁ through L₃ (refer to FIG. 11) are likely to occur between the ground outside the package and the internal ground because the package is not conductive. The parasitic inductances L₁ through L₃ tend to cause the ground potential inside the package with high frequencies. For example, when a high-frequency signal over 1 Gbps is received, the parasitic inductances L₁ through L₃ cause the following problems as mentioned earlier.

In the optical transceiver module, the parasitic inductance L₁ on the bonding wire connecting the photodetector 107 and the exterior of the package 100A, especially the parasitic inductance L₁ on the third bonding wire connecting the cathode terminal electrode 107A of the photodetector 107 (refer to FIG. 10) and the exterior of the package 100A degrades the high frequency characteristic.

In order to suppress degradation of the high frequency characteristic and obtain good high frequency characteristic, it is necessary to reduce the parasitic inductance L₁ on the cathode terminal of the photodetector 107. Thus, in general, the optical transceiver module 100 must be connected to the ground near the photodetector 107 or connected to a capacitor that is coupled to the ground to prevent degradation of the high frequency characteristic.

As mentioned earlier, the operation of a configuration where a capacitor is coupled between the cathode terminal of the photodetector 107 and the metal plate as the ground inside the package 100A is described below by using an equivalent. circuit model of FIG. 11.

As shown in FIG. 11, on the cathode and anode of the photodetector 107 are present parasitic inductances L₁ and L₂ on the third and fourth bonding wires 105C and 105D. Thus, in case the light emitting device 104 is driven with a current including a high-frequency signal, the potential of the anode terminal of the light emitting device 107 also varies with the high-frequency signal. The variation in the potential of the anode terminal of the light emitting device 107 with the high-frequency signal leaks from the anode terminal electrode 104A of the light emitting device 107 (refer to FIG. 10) to the metal plate 101 via a silicon substrate 103.

The first substrate 103 shown in FIG. 10 can be modeled into an equivalent circuit of a capacitor and a resistor as shown in FIG. 11. While the metal plate 101 is originally connected to an external ground, it is unstable due to the parasitic inductance L₃ on the fifth lead 102E as shown in FIG. 11. Thus, the high frequency potential variation of the anode terminal voltage of the light emitting device 104 propagates to the cathode terminal of the photodetector 107 by the added capacitor C via the metal plate 101.

With the above configuration, the potential variation of the cathode terminal voltage of the photodetector 107 acts as the variation in the light-receptive current. That is, in case a capacitor C is added to the cathode terminal of the photodetector 107 in the related-art optical transceiver module 100 (described in JP-A-2001-345475) in order to improve the high frequency characteristic in optical reception as shown in FIG. 11, electric crosstalk increases again.

### SUMMARY OF THE INVENTION

The invention has been accomplished in view of the aforementioned circumstances. An object of the invention is to provide an optical transceiver module that reduces electrical interference between a light emitting device and a photodetector while improving a high frequency characteristic in optical reception, and an optical transceiver including the same.

A first aspect of the invention provides an optical transceiver module comprising:

an approximately box-shaped package having a transceiver chamber inside;

first and second metal plates provided separately and independently of each other in the transceiver chamber of the package;

a first substrate provided on the first metal plate, the first substrate mounting a light emitting device;

a second substrate provided on the second metal plate, the second substrate mounting a photodetector;

an optical waveguide optically coupled to the light emitting device and the photodetector; and

a plurality of leads provided in the package, the leads providing electric connection between each electrode of the light emitting device and the photodetector and the exterior of the package.

A second aspect of the invention is characterized in that the package is formed of a resin.

With this configuration, the package part can be manufactured through resin molding, which can reduce the overall cost.

A third aspect of the invention is characterized in that a capacitor is included between the second metal plate and the cathode terminal of the photodetector, the capacitor electrically connecting the second metal plate and the cathode terminal of the photodetector.

With this configuration, by providing a capacitor for connecting the cathode terminal of the photodetector to the ground inside the package, the potential of the cathode of the photodetector is stabilized in terms of high frequencies. This suppresses electric crosstalk from the anode terminal of the light emitting device to the cathode terminal of the photodetector.

A fourth aspect of the invention is characterized in that the specific resistance value of the first substrate mounting the light emitting device is 1 kΩ·cm or above.

With this configuration, it is possible to suppress the amount of variation in the anode terminal potential due to a high-frequency signal propagating from the light emitting device to the first metal plate.

A fifth aspect of the invention is characterized in that at least either the first or the second metal plates is connected to a ground external to the package via the either lead.

With this configuration, it is possible to suppress the potential variation of the metal plate connected to the external ground.

A sixth aspect of the invention is characterized in that a preamplifier is mounted on the second metal plate and that electrical connection is established between the anode terminal of the photodetector and the input terminal of the preamplifier and between the output terminal of the preamplifier and any one of the leads.

With this configuration, the preamplifier enhances the amplification.

A seventh aspect of the invention is characterized in that the package has a through hole across the floor of the transceiver chamber and the bottom surface of the package and that at least either the first or the second metal plate is electrically conducted to the bottom surface of the package via the bottom surface of the metal plate and the through hole.

With this configuration, a lead for connecting to the exterior of the package is not required. This suppresses the potential variation of each metal plate caused by a parasitic inductance on the lead, thereby further reducing the electric crosstalk.

An eighth aspect of the invention is characterized in that a boundary part where the first and the second metal plate adjacently surface each other has a shape of cranks supplementing each other or a curve.

With this configuration, the gap between the two metal plates is not formed of a metal, that is, the gap includes a resin alone so that it is rather weak in terms of strength. The resin part is designed to avoid a straight shape. In other words, the part with less strength is formed into a zigzag shape while avoiding a long straight shape in order to disperse concentration of stress and effectively prevent possible breakage of a package or a component mounted in the package.

A ninth aspect of the invention is characterized in that the package has part of the transceiver chamber has an opening that is open outside and that

the opening is closed with a lid formed of a metal or ceramic.

With this configuration, the strength of the package is increased because of the lid.

A tenth aspect of the invention provides an optical transceiver mounting the optical transceiver module according to any one of the first through ninth aspects, characterized in that the substrate mounting the package of the optical transceiver module has an area lacking a conduction pattern in its area on the top surface thereof where the bottom surface of the package is in contact.

With this configuration, it is possible to avoid a case where a capacitance is generated between the conduction pattern on the bottom surface of the package and the first and second metal plates, which provides an effect like a capacitor, thereby increasing the capacitance of a path between the first and second metal plates and enhances the crosstalk.

### BRIEF DESCRIPTION OF THE DRAWINGS

FIG. 1 is a perpendicular sectional view mainly showing the optical configuration of an optical transceiver module according to the first embodiment of the invention;

FIG. 2 is a cross-sectional view mainly showing the electrical configuration of the optical transceiver module according to the first embodiment of the invention;

FIG. 3A is an explanatory drawing that shows the shape of a part between the first and second metal plates of the optical transceiver module according to the first embodiment of the invention;

FIGS. 3B through 3E are explanatory drawings that show variants of the shape of the part shown in FIG. 3A;

FIG. 4 is an explanatory drawing that shows an equivalent circuit in the optical transceiver module according to the first embodiment of the invention;

FIG. 5 shows variations in the crosstalk amount in the optical transceiver module according to the first embodiment of the invention and an optical transceiver module according to the relate art;

FIG. 6 is a cross-sectional view mainly showing the electrical configuration of the optical transceiver module according to the second embodiment of the invention;

FIG. 7 is a cross-sectional view mainly showing the electrical configuration of the optical transceiver module according to the third embodiment of the invention;

FIG. 8 is a schematic perspective view showing a pattern wiring on a substrate mounted in the optical transceiver according to the fourth embodiment of the invention;

FIG. 9 is a virtual equivalent circuit diagram used to illustrate the principle of the optical transceiver according to the fourth embodiment of the invention;

FIG. 10 is a cross-sectional view mainly showing the electrical configuration of the optical transceiver module according to the related art; and

FIG. 11 is an explanatory drawing that shows an equivalent circuit in the optical transceiver module according to the related art.

### BEST MODE FOR CARRYING OUT THE INVENTION

Embodiments of the invention will be detailed referring to attached drawings.

### First Embodiment

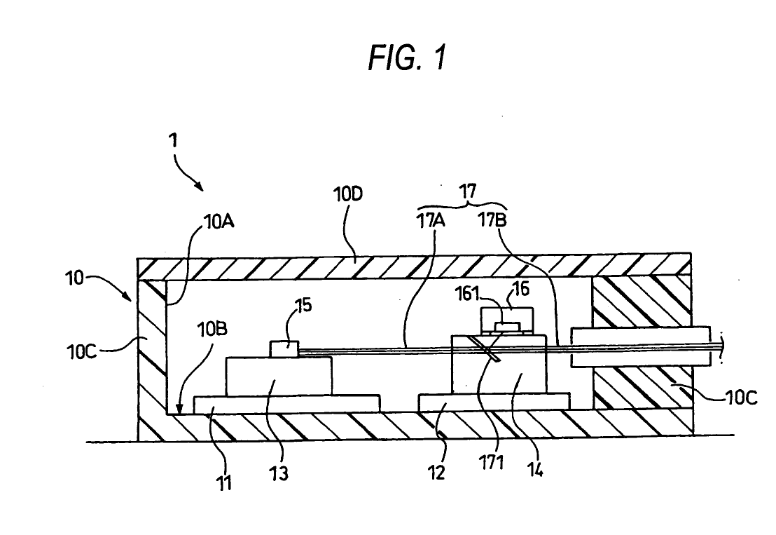

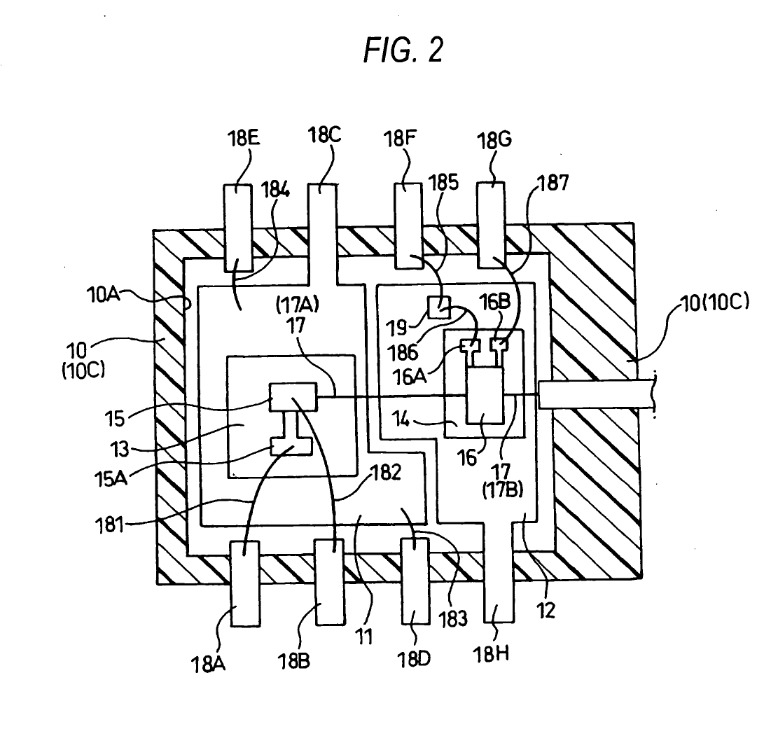

FIG. 1 and FIG. 2 show the configuration of an optical transceiver module according to the first embodiment of the invention. The optical transceiver module comprises, inside a package 10, a first metal plate 11 and a second metal plate 12 provided separately and independently of each other, a first substrate 13 and a second substrate 14 respectively provided on the metal plates, light emitting device 12 mounted on the first substrate 13, a photodetector 16 mounted on the second substrate 14, an optical waveguide 17, leads 18, and a capacitor 19.

The package 10 is a resin package formed of an appropriate resin material into a shape of an almost bottomed box in order to reduce the overall cost.

The package 10 comprises a removable lid 10D in order to enhance the strength and protect an optical device and an electric device inside, The lid 10D may be formed of the same resin material as the package main body or by an appropriate metal or ceramic in order to enhance the strength of the package.

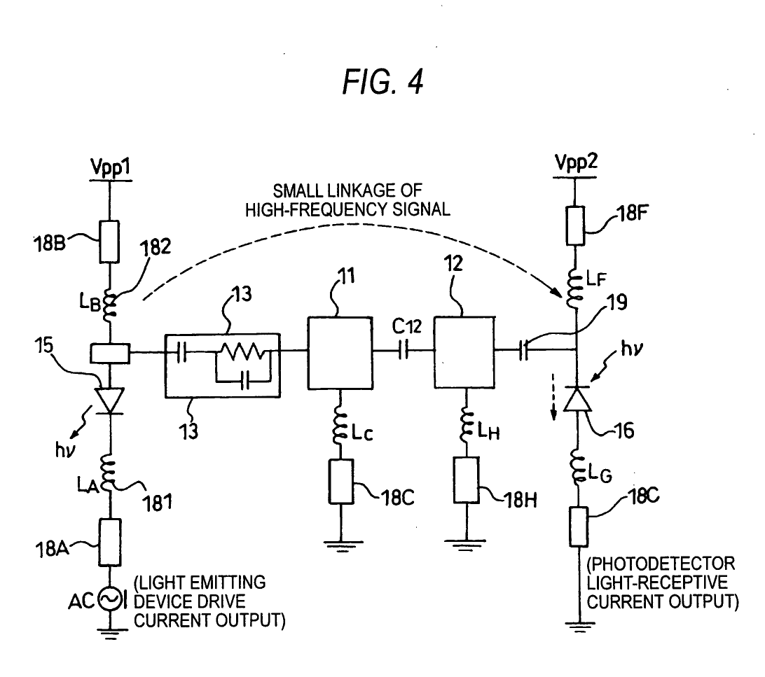

In case a resin package 10 is used, the package itself is generally non-conductive. Parasitic inductances L_{c}, L_{H} (refer to FIG. 4) that occur between the ground outside an external ground (not shown) and an internal ground could cause the ground potential in the package 10 to vary with high frequencies.

The invention avoids this trouble by adding a capacitor 19.

The package 10 has a transceiver chamber 10A formed inside it. The transceiver chamber 10A has first and second metal plates 11, 12 each functioning as an internal ground fixed on a floor B and leads 18 mentioned later embedded into a side wall 10C horizontally (almost in parallel with the floor 10B) so as to penetrate the transceiver chamber 10A across its interior and exterior.

Outside the package 10 is formed a ground mentioned earlier (not shown) that is called the “external ground”. The first and second metal plates 11, 12 are connected to the ground via the leads 18.

The first and second metal plates 11, 12 are separated from each other in order to reduce a capacitance C₁₂ that occurs between the first and second substrates 11, 12. Each of the first and second metal plates 11, 12 is formed of a metal conductor, in particular a CU alloy or Fe—Ni alloy and is formed into a shape that avoids a simple straight shape of an outer peripheries facing each other (called “opposed edges”).

The opposed edges of the first and second metal plates 11, 12 has a bent shape, for example a crank shape in this embodiment. Thus, the package 10 can avoid formation of a weak portion (that could be broken into two) in the approximate center of the floor 10B of the transceiver chamber 10A in a large length (large size).

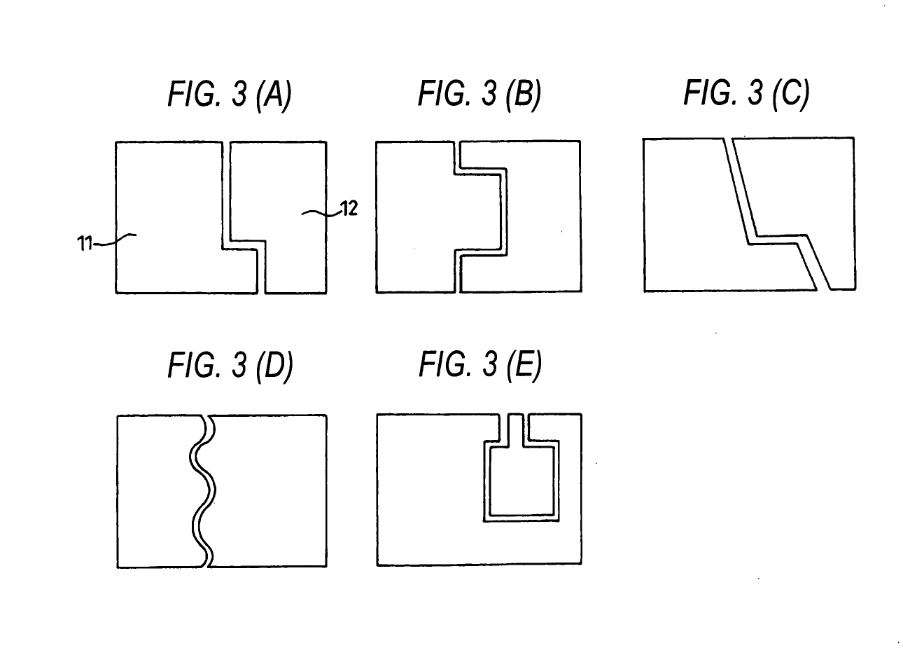

That is, the shape of the opposed edges of the first and second metal plates 11, 12 adjacent to each other is composed of three sides bent at two crank portions shown in FIG. 2 and FIG. 3A. This avoids formation of a less strong portion, or a portion where a metal plate is not installed (portion to be easily broken) in a long straight shape on the floor (bottom) of the package 10 between the metal plates.

The shape of the oppose edges of the first and second metal plates is not limited to that in this embodiment but various shapes shown in FIG. 1B through FIG. 3E are applicable. Note that, a shape of islands isolated from each other is difficult to manufacture so that it is not preferable.

On the top surface of the first plate 11 is mounted the first substrate 13. On the top surface of the second plate 12 is mounted the second substrate 14. The first substrate 13 is formed of a material having a high resistance, such as a specific resistance of at least 1 kΩ·cm, such as silicon (silicon substrate).

The second substrate 14 is a glass substrate formed of a general glass material such as quartz. Between the glass substrates forming upper and lower layers is arranged an optical waveguide 17 mentioned later, as shown in FIG. 2. In particular, an optical signal propagating from outside is reflected by a wavelength filter 171 mentioned later and propagates inside the second substrate 14 until it reaches the light-receptive part 161 of the photodetector 16. In order to allow the optical signal to propagate as efficiently as possible, the glass substrate is preferably formed of a material having small light attenuation properties. Strictly speaking, the optical signal passes through the substrate 14 and propagates in the air, then reaches the light-receptive part 161.

On the first and second substrate 13, 14 are preferably mounted a light emitting device 15 and a photodetector 16 via an insulating film formed of an appropriate insulating material. Thus, in this embodiment, an insulating film such as silicon oxide is provided on the top surface of the first substrate 13. The second substrate 14 is a glass substrate with high insulating properties and the optical signal is outgoing from the top surface, so that an insulating film is not provided on the top surface.

The light emitting device 15 uses a wavelength filter 171 (mentioned later) with high wavelength dependence, so that it employs a semiconductor laser (LD) that emits coherent light, near infrared light having a wavelength of 1.3 μm in this embodiment. The semiconductor laser (LD) feeds a current from the top surface (anode) to the bottom surface (cathode) of a device to emit near infrared light. In this embodiment, a current flows from the first lead 18A mentioned later to the bottom surface of the light emitting device 15 via the first bonding wire 181 and the anode terminal electrode 15A of the light emitting device 15 on the first substrate 13. From the top surface of the light emitting device 15, it is possible to drive with a current the light emitting device 15 from outside the package 10, via the second bonding wire 182 and the second lead 19B.

The light emitting device is not limited to the semiconductor laser of this embodiment but may be a light-emitting diode (LED) for short-range communications.

The photodetector 16 receives an optical signal transmitted from a distant party and converts it into an electric signal. In this embodiment, a PIN photodiode (PIN-PD) that outputs an electric signal on receiving transmission light having a wavelength of 1.5 μm so as to form an image on the light-receptive part 161 via an imaging lens.

The photodetector 16 has a cathode (terminal electrode 16A) provided on its bottom surface connected to a predetermined electronic circuit (not shown) external to the package 10 via the sixth and fifth bonding wires 186, 185 and the sixth lead 18F. Similarly, the photodetector 16 has an anode terminal connected to the predetermined electronic circuit (not shown) external to the package 10 via the seventh bonding wire 187 and the seventh lead 18G.

The photodetector 16 applies a voltage on the cathode terminal and the anode terminal. When an optical signal is received from the distant party, a current flows from the cathode terminal to the anode terminal, with the current amount varying with the level of the light received. This allows the optical signal transmitted from the distant party to be converted to an electric signal.

The photodetector 16 is not limited to a PIN photodiode (PIN-PD) in this embodiment but may be a photodiode such as an Avalanche Photodiode (APD).

The optical waveguide 17 optically couples the light emitting device 15 and the photodetector 16 respectively. The optical fiber a single-mode (SM) optical fiber formed of quartz glass for communications with a relatively remote location. The wavelength band used is 1.3 μm for transmission and 1.5 μm for reception.

In case an optical fiber is used as the optical waveguide 17, an optical fiber (POF) using a plastic material such as PMMA (polymethyl methacrylate) may be employed for relatively short-range communications. The wavelength of light used is preferably in the short wave band (visible light band) with better transmission efficiency than near infrared light, for example a 0.6 μm to 0.8 μm band.

The optical fiber is not particularly limited to the single mode type but may be a multimode optical fiber including a step index (SI) type and a graded index (GI) type.

The optical waveguide 17 may be a planar optical waveguide that confines light two-dimensionally or a channel optical waveguide that confines light in a three-dimensional path, rather than an optical five according to this embodiment.

A wavelength filter 171 is installed in a predetermined location of the optical waveguide 17 while embedded into the second substrate 14, so as to extract an optical signal of a predetermined wavelength from the distant party. The wavelength filter 171 transmits an optical signal having a wavelength of 1.3 μm to be transmitted from the light emitting device 15 to the distant party as well as selectively receives an optical signal having a wavelength of 1.5 μm to be transmitted from the distant party. To this end, the wavelength filter 171 is composed of a multilayer film interference filter using a dielectric multilayer film as selective reflection means having wavelength dependence. The wavelength filter 171 is arranged in a state where it is tilted at a predetermined proper angle with respect to the optical wavelength.

The lead 18 establishes electric connection between each electrode of the light emitting device 15 and the photodetector 16 and the exterior of the package 10 and is composed of a first lead 18A through eighth lead 18H.

Of these, the first lead 18A connects the anode (terminal electrode 15A) of the light emitting, device 15 and a predetermined part external to the package 10 via the first boning wire 181. The first boning wire 181, same as the second to seventh boding wires 182 through 187, is provided using a gold wire (or aluminum wire) by way of wire bonding.

The second lead 18B establishes electric connection between the upper surface of the light emitting device 15 and the exterior of the package 10 and drives the light emitting device 15 with a current from outside the package 10.

The third lead 18C is conducted to the first metal plate 11 and connects the first metal plate 11 and the ground (not shown) outside the package 10 in order to suppress potential variation of the first metal plate.

The fourth lead 18D and the fifth lead 18E are auxiliary terminals. The leads 18D and 18E connects the first metal plate 11 and the ground (not shown) via the bonding wires 183 and 184.

The sixth lead 18F establishes electric connection between the cathode terminal of the photodetector 16 and a dc voltage source external to the package 10 via the fifth bonding wire 185, sixth bonding wire 186 and the cathode (terminal electrode 16A) of the photodetector 16 on the glass substrate 14.

The seventh lead 18G establishes electric connection between the anode terminal (not shown) of the photodetector 16 and an amplifier external to the package via the anode terminal electrode 16B of the photodetector 16 on the glass substrate 14 and the seventh bonding wire 187. By applying a current across the sixth lead 18F and the seventh lead 18G from outside the package 10, the photodetector 16 obtains a light-receptive current according to the level of an optical signal received from an external distant party.

The eighth lead 18 is electrically conducted to the second metal plate 12 and connected to the ground (not shown) in order to suppress potential variation of the second metal plate 12.

The capacitor 19 forms a predetermined capacitance on its front and rear sides at the cathode (terminal electrode 16A) of the photodetector 16 and for example a chip capacitor. The capacitor 19 connects its rear surface to the ground (not shown) external to the package 10 in order to stabilized the potential of the cathode (terminal electrode 16A) of the photodetector 16 in terms of high frequencies. On the front surface, the capacitor 19 is connected to the cathode (terminal electrode 16A) of the photodetector via the sixth bonding wire 186.

The optical system of the optical transceiver module 1 according to this embodiment is the same as that in the related art. As mentioned earlier, inside the second substrate 14 are arranged one end of the first optical fiber 17A and one end of the second optical fiber 17B across a wavelength filter 171. The other end of the first-optical fiber 17A may be brought in close proximity to the light emitting surface of the light emitting device 15 so as to directly impinge an optical signal from the light emitting device 15 into the first fiber 17A. In this embodiment where the photodetector 16 is an appropriate optical device such as an LD having an isotropic light emission pattern, the other end may be arranged coaxially with the light emitting device 15 via an LD module having a spherical lens or a rod lens (not shown). The other end of the second optical fiber 17B serves as an external optical interface of the package 10.

In case an LED is used having an approximately isotropic light emitting pattern is used as the light emitting device 15, for example a microlens may be arranged between the light emitting device 15 and the first optical fiber 17A so as to focus the image of a light source into the core diameter thus enhancing the coupling efficiency.

An optical signal input from outside via the first optical fiber 17A is reflected on the wavelength filter 171 and received by the light-receptive part 161 of the photodetector 16. An optical signal output from the light emitting device 15 propagates inside the first optical fiber 17A, passes through the wavelength filter 171, propagates inside the second optical fiber 17B and is output from the optical transceiver module 1.

An equivalent circuit model of the optical transceiver module 1 according to the first embodiment is shown in FIG. 4.

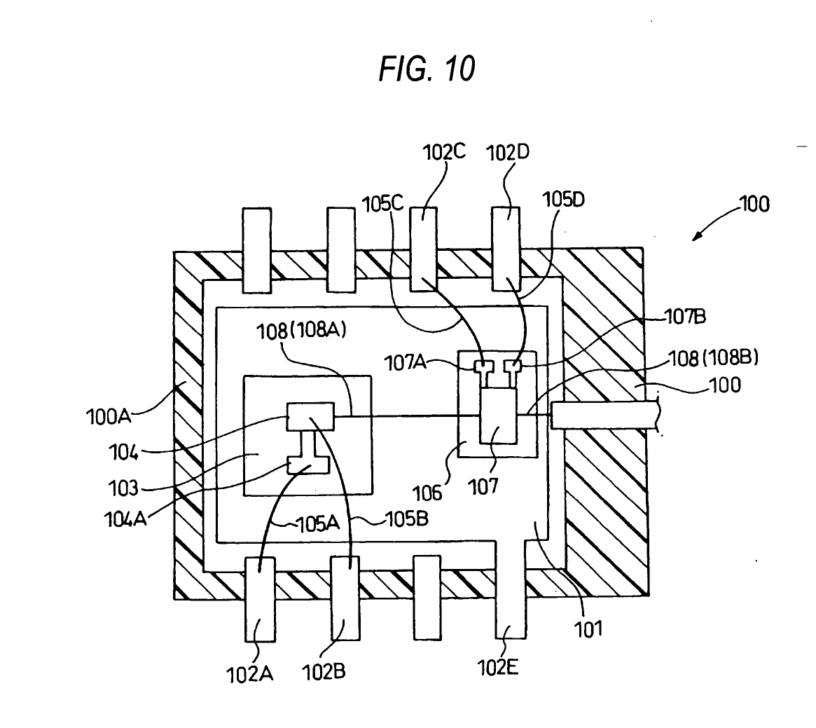

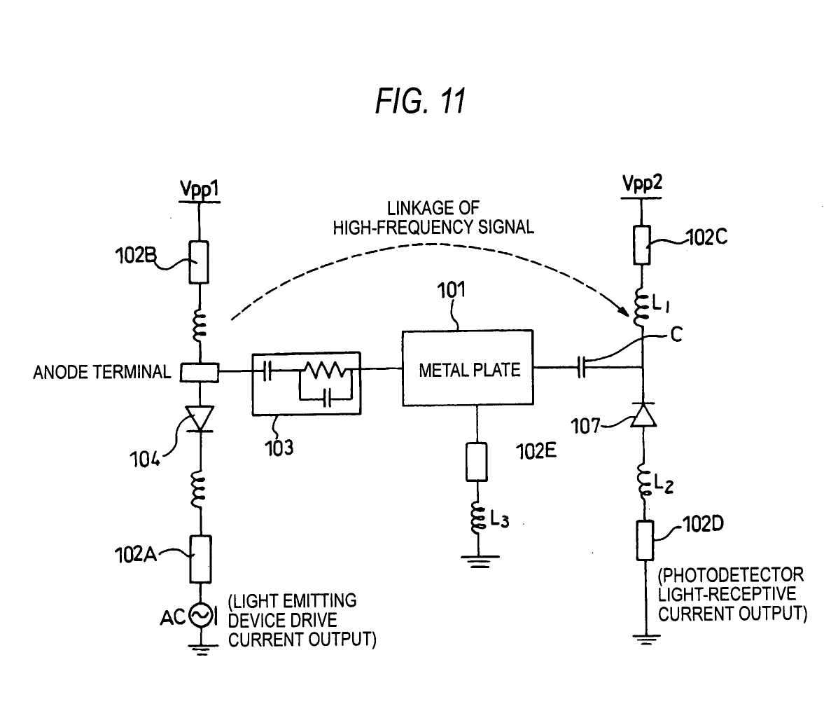

On the anode terminal and cathode terminal of the light emitting device 15 shown in FIG. 1 are parasitic capacitances L₁, L₁ (refer to FIG. 4) on the first and second bonding wires 181, 182. In case the light emitting device 15 is driven with a current including a high-frequency signal, the potential of the anode terminal of the light emitting device 15 also varies with the high-frequency signal. The variation in the potential of the anode terminal 15A of the light emitting device 15 with the high-frequency signal propagates from the anode terminal electrode 15A of the light emitting device 15 (refer to FIG. 10) to a first metal plate 11 via a first silicon substrate 13.

The first substrate 13 as a silicon substrate can be modeled using a capacitor and a resistor as shown in FIG. 4. By setting a high resistance (specific resistance value of 1 kΩ·cm or above), the amount of potential variation of the anode terminal caused by a high-frequency signal (on the light emitting device 15) propagating to the first metal plate 11 is reduced.

The first metal plate 11 is connected to the external ground via the third lead 18C. This suppresses the variation amount of the potential at the anode terminal of the photodetector 16. There occurs a capacitance C₁₂ between the first metal plate 11 and the second metal plate 12 although the capacitance is reduced to a very small amount (C₁₂) when a gap of 0.5 to 1.0 mm is provided between the first metal plate 11 and the second metal plate 12. As a result, the potential variation at the second metal plate 12 is further reduced compared with a case where a common metal plate is used.

The second metal plate 12 is connected to the external ground via the eighth lead 18H. Thus, the potential variation caused by a high-frequency signal from the light emitting device 15 is reduced. Even in case a capacitor 19 is added between the cathode (terminal electrode 16A) of the photodetector 16 and the second metal plate 12, the potential variation of the cathode terminal of the photodetector 16 is negligible.

In this way, according to this embodiment, the resistance value of the silicon substrate as the first substrate 13 is increased. The first metal plate 11 and the second metal plate 12 are separately provided and each of the first metal plate 11 and the second metal plate 12 is connected to the external ground. It is thus possible to minimize the potential variation of the cathode terminal of the photodetector 16 caused by a high-frequency signal that leaks from the potential variation of the anode terminal of the light emitting device 15, that is, an electric crosstalk. The capacitor 19 is added between the cathode terminal of the photodetector 16 and the second metal plate 12. This improves the high frequency characteristic of the photodetector 16.

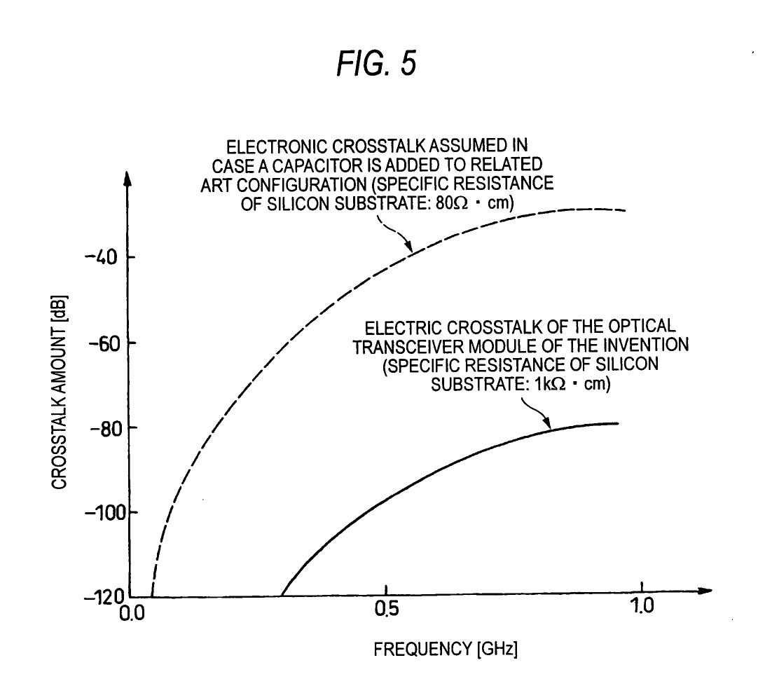

FIG. 5 shows a result of simulated crosstalk for a case (comparison case) where a capacitor is added on the cathode terminal of the photodetector in the related art optical transceiver module and a case of the optical transceiver module 1 of this embodiment. In FIG. 5, the axis of abscissa is laid off in a frequency (GHz) and the axis of ordinate is laid off in an electric crosstalk amount (dB). In FIG. 5, the smaller the value of the crosstalk amount is (the greater the absolute value is), the more favorable the arrangement is.

From FIG. 5, it is understood that the electric crosstalk amount increases as the frequency becomes higher in both the related art case and the case of this embodiment. Finding is obtained that the electric crosstalk amount is substantially improved in any frequency band for the inventive bidirectional optical module.

According to the configuration of the optical transceiver module 1 of this embodiment, by providing inside the package 10 a capacitor 19 for connecting the cathode terminal of the photodetector 16 to a ground, it is possible to suppress crosstalk from the anode terminal of the light emitting device 15 to the cathode terminal of the photodetector 16.

According to the configuration of the optical transceiver module of this embodiment, the opposed edges (sides) of the separate first and second metal plates 11, 12 adjacent to each other are almost parallel and have a shape of a crank with projections and depressions. Thus, even in case a relatively weak resin package is used as a package 10, a decrease in the bending strength of the optical transceiver module 1 is effectively suppressed. By providing a ceramic or metallic lid 10D (refer to FIG. 1) to the package 10, the bending strength is further enhanced.

### Second Embodiment

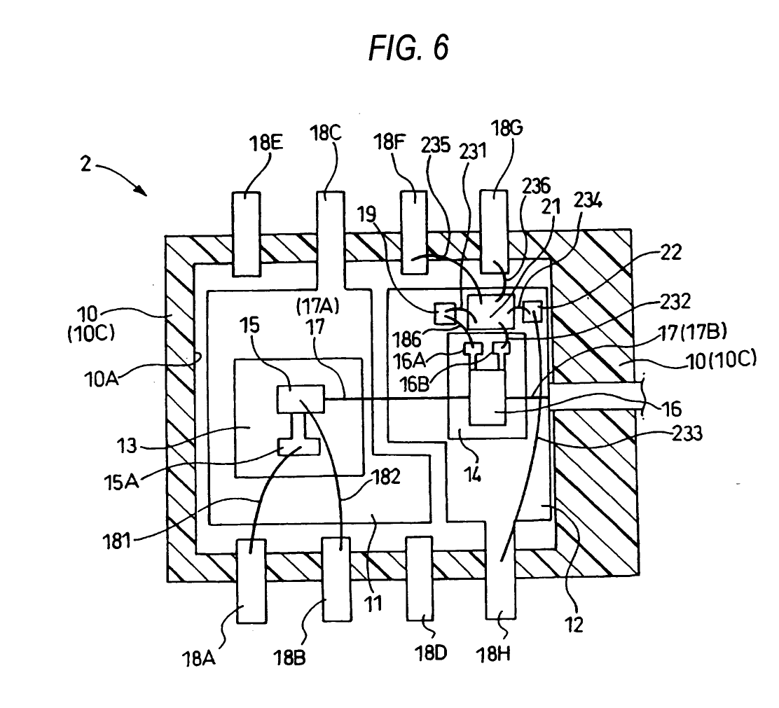

Next, the second embodiment of the invention will be described referring to FIG. 6. The same portions in this embodiment as the first embodiment are given the same signs and the duplicate description is omitted.

FIG. 6 shows the configuration of an optical transceiver module 2 according to the second embodiment of the invention. The optical transceiver module 2 has the same configuration as the optical transceiver module 1 according to the first embodiment except that a preamplifier 21 and a second capacitor 22 are additionally mounted on the second metal plate 12.

The preamplifier 21 is used to enhance the amplification. Electrical connection is established between the terminal (not shown) of the preamplifier 21 used to connect to the cathode of the photodetector 16 and the cathode of the photodetector 16 via the sixth bonding wire 186 and the eighth bonding wire 231. Electrical connection is established between the terminal (not shown) of the preamplifier 21 used to connect to the anode of the photodetector 16 and the anode terminal (anode terminal electrode 16B) of the photodetector 16 via the ninth bonding wire 232.

The preamplifier 21 of this embodiment amplifies an optical current in accordance with the optical input intensity from the photodetector 16 to convert the current to a differential signal. The preamplifier 21 includes two outputs, one output from a twelfth bonding wire 235 and a sixth lead 18F, the other output from a thirteenth bonding wire 236 and a seventh lead 18G. The preamplifier is powered via an eighth lead 18H, a tenth bonding wire 233 and an eleventh bonding wire 234.

A second capacitor 22 is provided to stabilize the potential of the power supply fed to the photodetector 16. The second capacitor 22 is provided between the sixth bonding wire 186 to connect to the cathode (terminal electrode 16A) of the photodetector 16 and the second metal plate 12

According to the optical transceiver module 2 of the second embodiment, same as the optical transceiver module 1 of the first embodiment, crosstalk to the cathode terminal of the photodetector 16 is reduced. Further, according to this embodiment, the preamplifier is incorporated into the transceiver chamber 10A of the package 10 thus improving the high frequency characteristic compared with the first embodiment, thereby outputting a signal having a larger amplitude.

### Third Embodiment

Next, the third embodiment of the invention will be described referring to FIG. 6. The same portions in this embodiment as the first embodiment are given the same signs and the duplicate description is omitted.

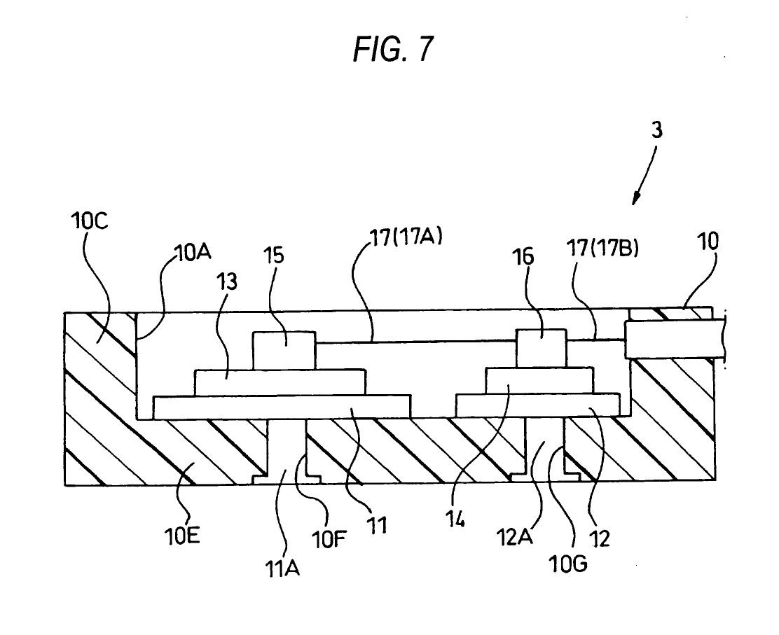

FIG. 7 shows the configuration of an optical transceiver module 3 according to the third embodiment of the invention. The optical transceiver module 3 of the third embodiment has the same configuration as the optical transceiver module 1 according to the first embodiment except that the former further comprises a through hole 10F that penetrates the bottom 10E of the package 10 at the bottom surface of the first metal plate 11, a conductive external connection metal 11A provided at the through hole 10F, a through hole 10G that penetrates the package 10 at the bottom surface of the second metal plate 12, and a conductive external connection metal 12A provided at the through hole 10G.

The first metal plate 11 and the conductive external connection metal 11A are either an integral metal or electrically coupled. Similarly, the second metal plate 12 and the conductive external connection metal 12A are either an integral metal or electrically coupled.

By connecting the optical transceiver module to a ground external to the package 10 via the conductive external connection metals 11A, 12A, it is possible to still efficiently suppress the potential variation caused by crosstalk between the first metal plate and the second metal plate 12, thereby further reducing electric crosstalk.

### Fourth Embodiment

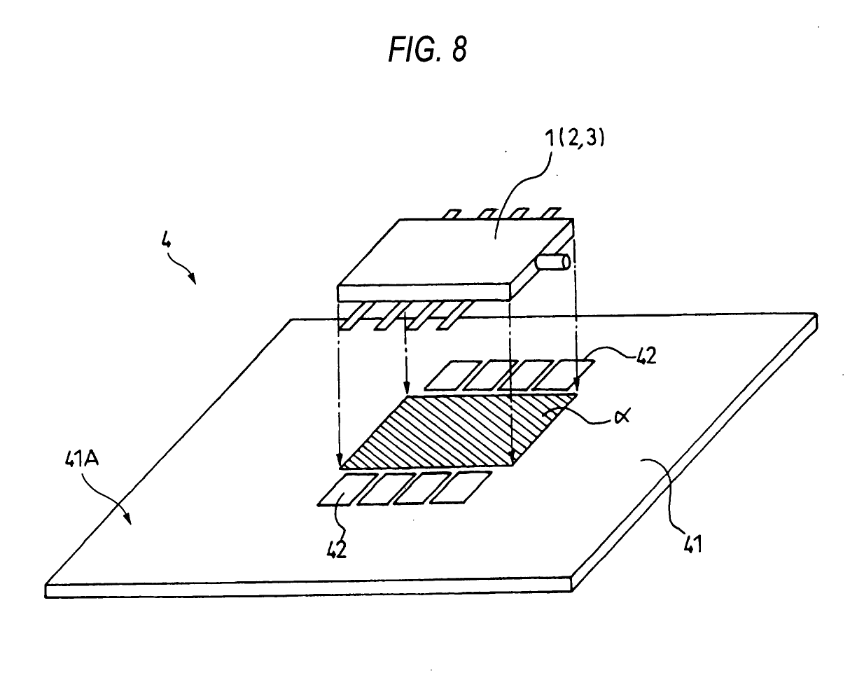

Next, an optical transceiver according to the invention will be described referring to FIG. 8.

FIG. 8 shows an optical transceiver 4 according to an embodiment of the invention. The optical transceiver 4 comprises a mounting substrate 41 that includes a predetermined pattern wiring 42 on its top surface and any one of the optical transceiver modules 1 through 3 used in the first through third embodiments, the on of the optical transceiver modules mounted on the front surface (top surface) 41A of the mounting surface 41.

On the mounting substrate 41 where an optical transceiver module is to be mounted is mounted any one of the optical transceiver modules 1 through 3 used in the first through third embodiments. In particular, an area α of the front surface (top surface) 41A of the mounting substrate 41 that is in contact with the rear surface of the package 10 of the optical transceiver modules 1 through 3 (the area cross-hatched in FIG. 8; hereinafter referred to as the “package mounting area”) does not include a conductive pattern (which is called a missing pattern).

In this way, the optical transceiver 4 of the invention does not provide a pattern wiring 42 (missing pattern) in the package mounting area α. The reason for this arrangement will be described.

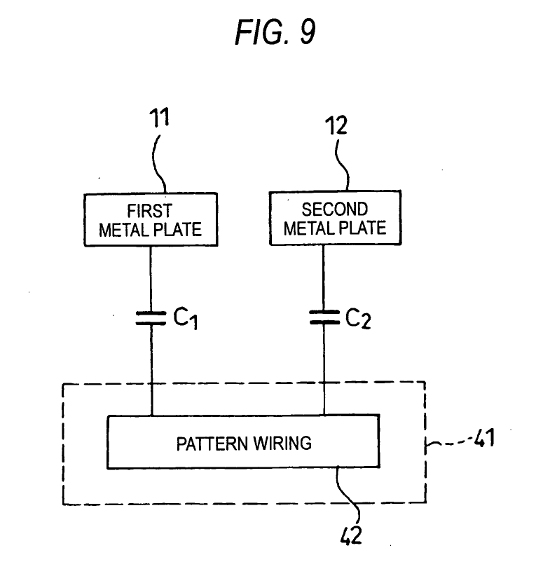

Unlike this embodiment, an equivalent circuit model assumed in case a pattern wiring 42 is provided (the missing pattern is avoided) also in the package mounting area α of the front surface (top surface) of the mounting substrate 41 is shown in FIG. 9.

In this case, same as this embodiment, the package 10 of the optical transceiver module 1 (or 2, 3) is formed of a resin and constitutes a dielectric in terms of physical properties. On the front surface (top surface) 41A of the mounting substrate 41 assumed when the package mounting area α does not include a missing pattern invites a capacitance C₁ between the first metal plate 11 and a pattern wiring on the mounting substrate 41, since the pattern wiring is included just below the package 10. Similarly, a capacitance C₂ appears between the second metal plate 12 and the pattern wiring on the mounting substrate 41 just below the package 10.

In the absence of a missing pattern, as shown in FIG. 9, a capacitance connection-occurs between the first metal plate 11 and the second metal plate 12. As a result, the electric crosstalk develops there.

In the optical transceiver 4 according to the fourth embodiment of the invention, a conductive pattern is not provided in the package mounting area α of the optical transceiver module 1 (or 2, 3) just below the package 10 of the optical transceiver module. This avoids occurrence of the capacitance C₁ and C₂, thereby preventing electric crosstalk from developing.

While the invention has been described in detail referring to specific embodiments, those skilled in the art will recognize that various changes and modifications can be made in it without departing from the spirit and scope thereof.

This application is based on the Japanese Patent Application No. 2004-008118 filed Jan. 15, 2004 and its contents are incorporated herein as a reference.

According to the invention, a first metal plate having a first substrate for mounting a light emitting device and a second metal plate having a second substrate for mounting a photodetector are provided separately and independently of each other in a resin package, thus reducing the parasitic capacitance. This provides an effect of suppressing electric crosstalk where part of a high-frequency signal causes a variation in the potential at a terminal of a photodetector while improving the high frequency characteristic in driving the light emitting device with a high-frequency signal. The invention is effective for use in an optical transceiver module and an optical transceiver comprising the same.

1. An optical transceiver module comprising:
an approximately box-shaped package, having a transceiver chamber inside;
first and second metal plates, provided separately and independently of each other in the transceiver chamber of the package;
a first substrate, provided on the first metal plate, the first substrate mounting a light emitting device;
a second substrate, provided on the second metal plate, the second substrate mounting a photodetector;
an optical waveguide, optically coupled to the light emitting device and the photodetector; and
a plurality of leads provided in the package, the leads providing electric connection between each electrode of the light emitting device and the photodetector and the exterior of the package.

2. The optical transceiver module according to claim 1, wherein the package is formed of a resin.

3. The optical transceiver module according to claim 1, wherein a capacitor is included between the second metal plate and the cathode terminal of the photodetector, the capacitor electrically connecting the second metal plate and the cathode terminal of the photodetector.

4. The optical transceiver module according to claim 1, wherein the specific resistance value of the first substrate mounting the light emitting device is 1 kΩ·cm or above.

5. The optical transceiver module according to claim 1, wherein at least either the first and the second metal plates is connected to a ground external to the package via the either lead.

6. The optical transceiver module according to claim 1, wherein a preamplifier is mounted on the second metal plate and that electrical connection is established between the anode terminal of the photodetector and the input terminal of the preamplifier and between the output terminal of the preamplifier and any one of the leads.

7. The optical transceiver module according to claim 1, wherein the package has a through hole across the floor of the transceiver chamber and the bottom surface of the package and at least either the first or the second metal plate is electrically conducted to the bottom surface of the package via the bottom surface of the metal plate and the through hole.

8. The optical transceiver module according to claim 1, wherein a boundary part where the first and the second metal plate adjacently surface each other has a shape of cranks supplementing each other or a curve.

9. The optical transceiver module according to claim 1, wherein the package has part of the transceiver chamber has an opening that is open outside and the opening is closed with a lid formed of a metal or ceramic.

10. An optical transceiver mounting the optical transceiver module according claim 1, wherein the substrate mounting the package of the optical transceiver module has an area lacking a conduction pattern in its area on the top surface thereof where the bottom surface of the package is in contact.
